(19) United States
(12) Patent Application Publication
(10) Pub. No.: US 2020/0276707 A1
(43) Pub. Date: Sep. 3, 2020

(54) METHOD AND SYSTEM FOR CLOUD-BASED PROGRAMMING AND CONTROL OF ROBOTIC PLATFORM

(71) Applicant: Ohmnilabs, Inc., Santa Clara, CA (US)

(72) Inventors: Jared Go, Mountain View, CA (US); Tingxi Tan, Coquitlam (CA); Thuc Vu, San Jose, CA (US)

(73) Assignee: Ohmnilabs, Inc., Santa Clara, CA (US)

(21) Appl. No.: 16/289,104

(22) Filed: Feb. 28, 2019

(51) Int. Cl. B25J 9/16; G06F 9/54

(52) U.S. Cl. CPC B25J 9/1658; B25J 9/1689; G06F 9/548

(57) ABSTRACT

A method, system, and apparatus in the form of a robotic platform. When implemented as described, the method and system provide a highly flexible open platform for efficient and agile code development for robotic platforms through a cloud-based API. The method and system also allow developers to test new robotic platform programming immediately via the Internet and observe the results in real time, even for geographically remote robotic telepresence systems.

### BACKGROUND

A robotic telepresence system is a type of robotic platform that provides remote face-to-face communication in home, medical, education, or business applications. A telepresence robot typically includes audiovisual (AV) components such as a web camera, a microphone, a display screen, and a speaker. These AV components are mounted on a movable frame and equipped with sensors that allow it to detect and navigate around obstacles in the robot's environment.

Telepresence robots are typically controlled by means of an interface application installed on computer workstations, wherein the computer workstations are also equipped with similar AV components. This allows a user at a computer workstation to have remote face-to-face interaction with a remote target user in proximity to the telepresence robot. In addition, artificial intelligence programmed into the telepresence robot allows it to interact with remote target users in its environment in a stand-alone capacity, without direct control from a user at a computer workstation, and without participating in a telepresence AV call.

In spite of the flexible nature and broad applicability of these robotic systems, open platforms for robotic telepresence software development are limited. This prevents many users from taking full advantage of the features of the systems with which they interact. In addition to novel code they may wish to create, individual program developers must typically recreate the entire code stack needed for basic telepresence functionality. They must often accomplish this in a vacuum, with few opportunities to leverage existing code, and without a standard, readily available application programming interface (API) to draw from.

In addition, reprogramming a telepresence robot must often be done manually, in person. Thus, it can be difficult to modify or augment the programming of a telepresence robot in a location geographically distant from the program developer. Even when the developer is able to update the robot's programming in person, the iterative testing process needed to observe the results of new code and correct programming errors discovered through undesired behavior can be cumbersome. The need to manually reprogram the robot also precludes a developer from sending additional commands “on-the-fly,” to be executed in real-time, whether or not the robot is currently in a telepresence call.

There is a need for a standard, readily accessible API platform that facilitates development of scalable and reusable code, and a programming method and system through which code can be sent immediately to the robotic telepresence, whether proximal to or remote from the developer's location, to enable more agile and efficient software development and enhanced real-time performance capabilities.

### BRIEF SUMMARY

This disclosure relates to a method in which a cloud-based application programming interface (API) may be deployed, wherein the cloud-based API comprises programming commands and routines for controlling a robotic platform and exists on a cloud-based API server that is accessible to program developers through the Internet. The cloud-based API may be accessed through the Internet using an Internet browser installed on a computer workstation. A programming web page may be developed, wherein the programming web page is constructed by the program developer as a standard web-based programming language file, includes a command to include the cloud-based API within the web-based programming language file, and contains the programming commands and the routines included in the cloud-based API. The programming web page may be saved on the Internet, and may be accessible to the robotic platform via a uniform resource locator (URL). The URL may be sent to the robotic platform using a cloud-based developer interface, wherein the cloud-based developer interface exists on the cloud-based API server, the robotic platform is connected to the cloud-based developer interface through the Internet, and the robotic platform includes an API web execution engine, wherein the API web execution engine includes logic for generating instructions for the robotic platform from the programming web page. The URL for the programming web page may be received at the API web execution engine, which may then retrieve the programming web page from the Internet and generate instructions for the robotic platform. The instructions may be processed through a system core processor, wherein the system core processor exists in the robotic platform and controls the robotic platform's motion, sensing, and user input/output (I/O) functions. As a result, the robotic platform may execute the instructions controlling motion, sensing, and user I/O functions.

This disclosure further relates to a system wherein a cloud-based developer interface may be accessible to program developers over the Internet and may provide a graphical user interface (GUI). The GUI may allow program developers to send a uniform resource locator (URL) to a robotic platform. A cloud-based API may be located on a server that is accessible over the Internet. The cloud-based API may comprise programming commands and routines for controlling the robotic platform. The cloud-based API server may host the cloud-based developer interface, store the cloud-based API, and include routing logic that allows the program developer to access the robotic platforms. The system may include the robotic platform, which may connect to the Internet and may have an API web execution engine capable of processing the programming commands and the routines in the cloud-based API.

Finally, this disclosure relates to a robotic platform with an audiovisual (AV) input and output system that may provide face-to-face communication functionality, including at least one of a display, speaker, camera, microphone, and combinations thereof. The robotic platform may include a mobility system controlling its motion, a sensory system providing environmental data, a network controller providing a connection to the Internet, an application programming interface (API) web execution engine that translates a programming web page into instructions for the robotic platform, and a system core processor that processes the instructions from the API web execution engine and executes the instructions to control the robotic platform's motion, sensing, and user I/O functions.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system overview 100 in accordance with one embodiment.

FIG. 2 illustrates a method 200 in accordance with one embodiment.

FIG. 3 illustrates a developer system 300 in accordance with one embodiment.

FIG. 4 illustrates a server system 400 in accordance with one embodiment.

FIG. 5 illustrates a robot system 500 in accordance with one embodiment.

FIG. 6 illustrates a remote target user display 600 in accordance with one embodiment.

FIG. 7 illustrates a typical programming web page 700 in accordance with one embodiment.

### DETAILED DESCRIPTION

To encourage independent program developers to experiment with and ultimately enhance robotic platform programming, the methods and systems disclosed herein may allow developers to leverage existing programming code rather than recreating everything from scratch for each application. They may also facilitate the programming of robots that may be geographically remote from the developer. This may be accomplished by providing a method, system, and robotic platform architecture by which a standard set of programming commands and routines may be used to construct code that may be transmitted to robotic platforms over the Internet. Such a solution may face numerous technical challenges.

The method, system, and robotic platform disclosed herein may greatly enhance the ease of code development and deployment, as well as access to digital resources. With the cloud-based API described herein, program developers may have full and easy access to every piece of content on the Internet. This content may be downloaded to a robotic platform just as easily as can be done with any Internet browser, rather than requiring the developer to learn and use new, low-level APIs. In this manner, the solution disclosed herein greatly reduces the effort needed to package and deploy code to a robotic platform.

One embodiment of a robotic platform is a telepresence robot. The central function of telepresence robots (i.e., to facilitate AV data streaming between a user at a computer workstation and a user sitting with the robot) may depend on an uncompromised connection to the Internet. Transmitting large code files over the Internet, instead of uploading them directly to the robot via a USB or other wired connection, may interfere with the telepresence robot's ability to perform its central function. This problem may be avoided by transferring code only while the robot is not engaged in a telepresence call (“in-call”). The usefulness for such code may be limited, though, as most of a telepresence robot's functionality may happen in-call. Thus, code files may need to be relatively small and easy to process to be effectively deployed over the Internet without interfering with basic telepresence functionality.

Many programmers wishing to develop useful programming for telepresence robots may not be familiar with programming languages needed to interact directly with the processor or low-level components. Even those able to code for the robot core logic directly may need to create programs that first replicate the entire code stack needed for the robot's basic telepresence functions before they can include commands for functions they wish to add.

Program developers not geographically near their telepresence robots may not have complete knowledge of all hardware installed on those robots. Thus, developers may not be able to correctly instruct the processor to activate and read all onboard actuators and sensors.

The solution disclosed here addresses these challenges by implementing a programming method and system based on common Internet coding languages and practices. A standardized application programming interface (API) may be accessed via the Internet (i.e., “cloud-based”). The cloud-based API may be based on a common scripting language, such as JavaScript. The API may provide standardized, reusable programming commands and routines, including the entire code stack needed for basic telepresence call functionality. A cloud-based developer interface may also be provided and may be accessed using a computer workstation with an Internet browser installed. The developer interface may allow a program developer to implement API commands and routines in the form of HTML files, or other typical web page files, by allowing the developer to send URLs for the programming web pages to the robot over the Internet. The telepresence robot logic architecture may include an API web execution engine capable of reading standard web coding languages and translating web coding into commands for the robot's system core processor.

Programs in HTML, XML, JavaScript, and other common web-coding languages may be saved as ASCII text files. Compared to the bandwidth needed to maintain a streaming AV connection with acceptably low latency and data droppage, downloading and parsing an ASCII text file may require relatively little signaling and processing bandwidth. Thus, implementing a web page-based solution may significantly mitigate the problem of code transfer over the Internet interfering with basic AV streaming capability.

Many program developers may already be familiar with languages like HTML, XML, and JavaScript. Using an API and code file format based on these languages may make it quite easy for any developer to create telepresence robot code. For developers unfamiliar with these languages, numerous training resources may be found on the Internet. No specialized, standalone applications may be needed to develop or deploy a programming web page. In essence, this solution may allow anyone who has a computer and can write a web page to develop programs for a telepresence robot.

Finally, the API web execution engine may translate commands in high-level languages like JavaScript and HTML into machine language that may be read by the robot's system core processor. Basing the API on an object-oriented programming language such as JavaScript may allow program developers to focus on high-level functions instead of low-level command code, making the API versatile enough for use on telepresence robots that may have different hardware components installed. The system core processor may manage the specific code needed to directly command actuators, sensors, and AV components of any type or brand, which may free the program developer from the need to know exactly what hardware the robot has installed.

In addition to these benefits, employing this method and system of robotic programming, wherein programs are developed using a cloud-based API encapsulated in a web page and delivered over connection to the Internet, may provide another layer of flexibility. Anything that may be accessed on the Internet using a uniform resource locator (URL), and anything that may be scripted on a web page for processing by a typical Internet browser, may be included as part of the programming web page.

In one embodiment, a programming web page may instruct the telepresence robot to play a video stored on YouTube, display a slideshow of photos stored on Flickr, play an audio file, display messages written in text files, etc. If the robot is part of a telepresence application for a specific company, programming web pages may reference the company's online cascading style sheet (CSS) files in order to appropriately brand any content displayed on screen. The entire Internet may be seen as a library from which media can be accessed for use in a telepresence robot application, whether the robot is in-call or out-of-call. The robot may also be able to access the latest deep learning models or upload training data for improved machine learning. Such media, learning, and training data may therefore be available to the robot, with no need to take up storage space in the robot's long-term memory.

In one embodiment, a cloud-based developer interface may allow a developer to set a home page for the telepresence robot. The URL for this page may be stored in robot memory, taking up minimal memory space. It may be accessed on startup, and the home page may in turn link to additional pages of code to activate additional robot functionality. Because the programming web pages themselves may be saved online and accessed over the Internet, much of the programming required to operate the robot with full functionality may be stored in the cloud, not in the robot.

In one embodiment, a programming web page may contain a combination of cloud-based API commands, HTML code, and additional JavaScript routines to generate a graphical user interface (GUI). The cloud-based developer interface may include an “overlay” field allowing the program developer to deploy an overlay file during a call, wherein the URL entered in the overlay field may point to the web page containing code for the GUI. In this manner, the remote target user interacting with the telepresence robot may be able to select from a GUI menu of options to provide information to the developer, or to activate certain robot functions, with no interruption in the telepresence call.

In one embodiment, a programming web page may contain code that allows it to interact in real time with data processed through a browser extension installed in the program developer's instance of their Internet browser. For example, a browser may have an extension that allows the browser to accept input from virtual reality (VR) controllers, such as VR gloves or glasses. The developer may take advantage of this functionality to script a program that allows the developer to remotely control the robot in real-time using VR gloves.

In one embodiment, a programming web page may contain code that causes the cloud-based developer interface to appear on part of a telepresence robot's screen. The remote target user may then be able to load a URL such that the telepresence robot in their vicinity may now be used to program other robots.

In an embodiment, a method may include deploying a cloud-based application programming interface (API) that comprises programming commands and routines for controlling a telepresence robot and exists on a cloud-based API server. The cloud-based API may be accessed through the Internet using an Internet browser installed on a computer workstation. A programming web page may be developed, wherein the programming web page is constructed by the program developer as a standard web-based programming language file, includes a command to include the cloud-based API within the web-based programming language file, and contains the programming commands and the routines included in the cloud-based API. The programming web page may be saved on the Internet, and may be accessible to the telepresence robot via a uniform resource locator (URL). The URL may be sent to the telepresence robot using a cloud-based developer interface, wherein the cloud-based developer interface exists on the cloud-based API server, the telepresence robot is connected to the cloud-based developer interface through the Internet, and the telepresence robot includes an API web execution engine, wherein the API web execution engine includes logic for generating instructions for the telepresence robot from the programming web page. The URL for the programming web page may be received at the API web execution engine, which may then retrieve the programming web page from the Internet and generate instructions for the telepresence robot. The instructions may be processed through a system core processor, wherein the system core processor exists in the telepresence robot and controls the telepresence robot's motion, sensing, and user input/output (I/O) functions. As a result, the robot may execute the instructions controlling motion, sensing, and user I/O functions.

The programming web page may be an HTML file or an XML file. The programming web page may include links to at least one of video, audio, image files, and combinations thereof, that exist on the Internet. The programming web page may include links to other web pages that exist on the Internet, wherein the other web pages include at least one of additional programming web pages the telepresence robot executes and informational web pages the telepresence robot displays providing information useful to persons interacting with the telepresence robot. The programming web page may include commands to construct graphical user interfaces (GUIs). The programming web page may include commands that interact with browser extension code incorporated into the Internet browser. The programming web page may include programming commands that allow the telepresence robot to control other robots compatible with the telepresence robot.

The program developer may access a shared library on the cloud-based API server to upload the programming web pages he/she has created. In such an embodiment, other program developers may be able to access and make use of these shared programming web pages. A programmer may access the cloud-based API via a wired or wireless Intranet connection to the cloud-based API server.

In an embodiment a system may include a cloud-based developer interface accessible to program developers over the Internet and may provide a graphical user interface (GUI). The GUI may allow program developers to send a uniform resource locator (URL) to a telepresence robot. A cloud-based API may be located on a server that is accessible over the Internet. The cloud-based API may comprise programming commands and routines for controlling the telepresence robot. The cloud-based API server may host the cloud-based developer interface, store the cloud-based API, and include routing logic that allows the program developer to access the telepresence robots. The system may include the telepresence robot, which may connect to the Internet and may have an API web execution engine capable of processing the programming commands and the routines in the cloud-based API.

The cloud-based developer interface may allow the program developer to send the URL at which a homepage is accessible, wherein the homepage is a programming web page and wherein the URL is stored in memory within the telepresence robot, and the telepresence robot reads the URL and accesses and executes the homepage at startup. The cloud-based developer interface may allow the program developer to send the URL for a homepage, wherein the homepage is a programming web page and wherein the telepresence robot downloads the homepage located at the URL, saves the homepage in memory within the telepresence robot, and executes the homepage at startup. The cloud-based developer interface may allow the program developer to send the URL for a programming web page and wherein the programming commands and the routines included in the programming web page are executed immediately instead of the programming commands and the routines the telepresence robot is in process of executing. The cloud-based developer interface may allow the program developer to send the URL for a programming web page and wherein the programming web page is executed as an overlay to the programming commands and the routines the telepresence robot is in process of executing. The cloud-based developer interface may allow the program developer to perform at least one of the following: assign a name to the telepresence robot, modify the name assigned to the telepresence robot, assign a color setting for LED lamps incorporated into the telepresence robot, perform a remote code update of the telepresence robot, perform a remote reboot of the telepresence robot, and some combination thereof.

The cloud-based API server may provide wired access for a user connecting over a local intranet in addition to cloud-based access over the Internet. The cloud-based API server may include a library to which the program developer uploads the programming commands and the routines that he/she develops.

In an embodiment, a telepresence robot may include an audiovisual (AV) input and output system that provides face-to-face communication functionality, including at least one of a display, speaker, camera, microphone, and combinations thereof. The robot may include a mobility system controlling its motion, a sensory system providing environmental data, a network controller providing a connection to the Internet, an application programming interface (API) web execution engine that translates a programming web page into instructions for the telepresence robot, and a system core processor that processes the instructions from the API web execution engine and executes the instructions to control the telepresence robot's motion, sensing, and user I/O functions.

The telepresence robot may incorporate a wired connection over which a program developer may upload the programming web pages directly to memory within the telepresence robot.

The mechanisms that enable this solution are described in detail below and illustrated in the referenced figures. While the telepresence robot is the primary robotic platform embodiment described, it may be understood by one skilled in the art that the method, system, and apparatus disclosed herein may be applied to a plurality of robotic platform types.

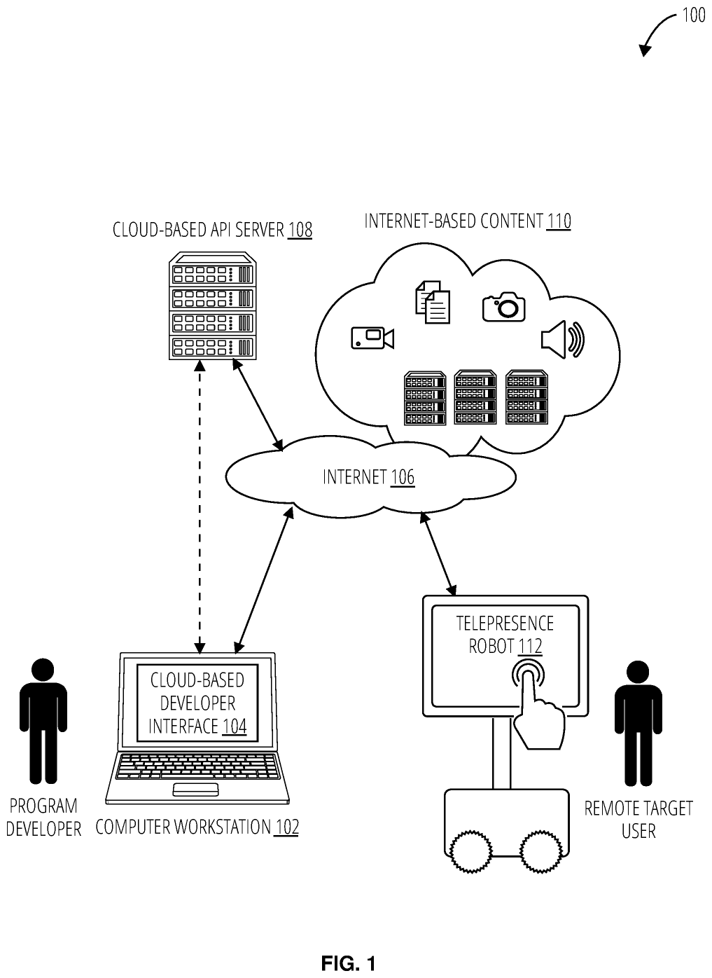

Referring to FIG. 1, a system overview 100 comprises a computer workstation 102, a cloud-based developer interface 104, a cloud-based API server 108, and a telepresence robot 112.

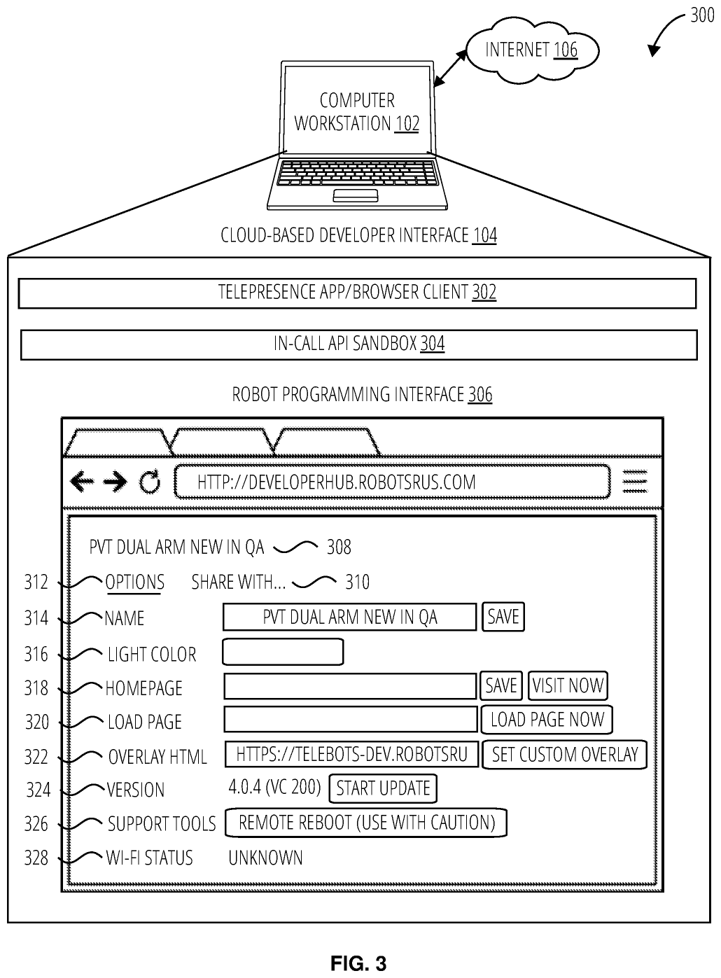

A user wishing to develop new code for the telepresence robot 112 may access a cloud-based developer interface 104 using any Internet browser installed on their computer workstation. The cloud-based developer interface 104 may be hosted on a cloud-based API server 108. The cloud-based developer interface 104 may allow the developer to access the server and control the robot with no need to implement a specialized, stand-alone application. The cloud-based developer interface 104 is illustrated in more detail in FIG. 3.

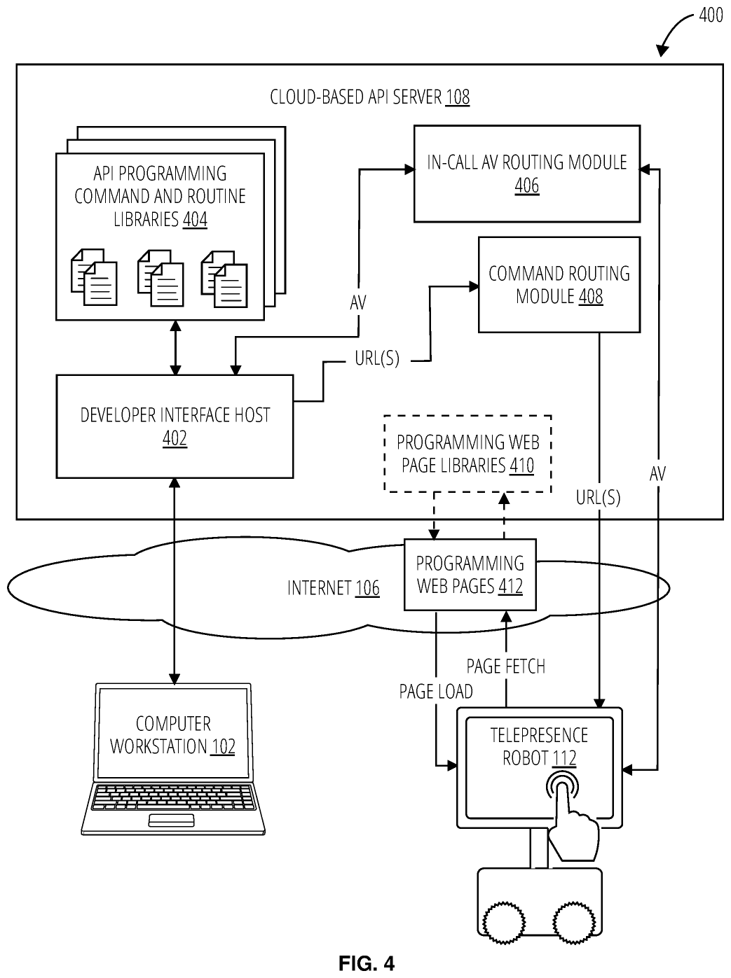

The cloud-based API server 108 may host the cloud-based developer interface 104 allowing developers to control the telepresence robot 112 through an Internet browser. The cloud-based API server 108 may store API programming command and routine libraries 404 comprising control code for the robot, including the code stack needed to control basic AV telepresence functionality. In one embodiment, the developer may access the cloud-based API server 108 over a wired or wireless intranet connection, instead of the Internet. The cloud-based API server 108 is illustrated in more detail in FIG. 4.

The cloud-based API server 108 and cloud-based developer interface 104 together may allow developers to implement high-quality telepresence out-of-the-box by providing an open platform comprising the necessary code. Developers may then easily customize and deploy their own web applications on top of the telepresence code to take advantage of additional robot functionality. In addition to commands and routines stored on the cloud-based API server 108, the developer may pull additional Internet-based content 110 into their programs, such as video, audio, and image files, additional web pages, web-based graphical user interfaces (GUIs), web browser extension coding, etc. For example, a developer may encode the programming web page to interact with their browser extension such that they may use VR gloves to control the motion of the telepresence robot.

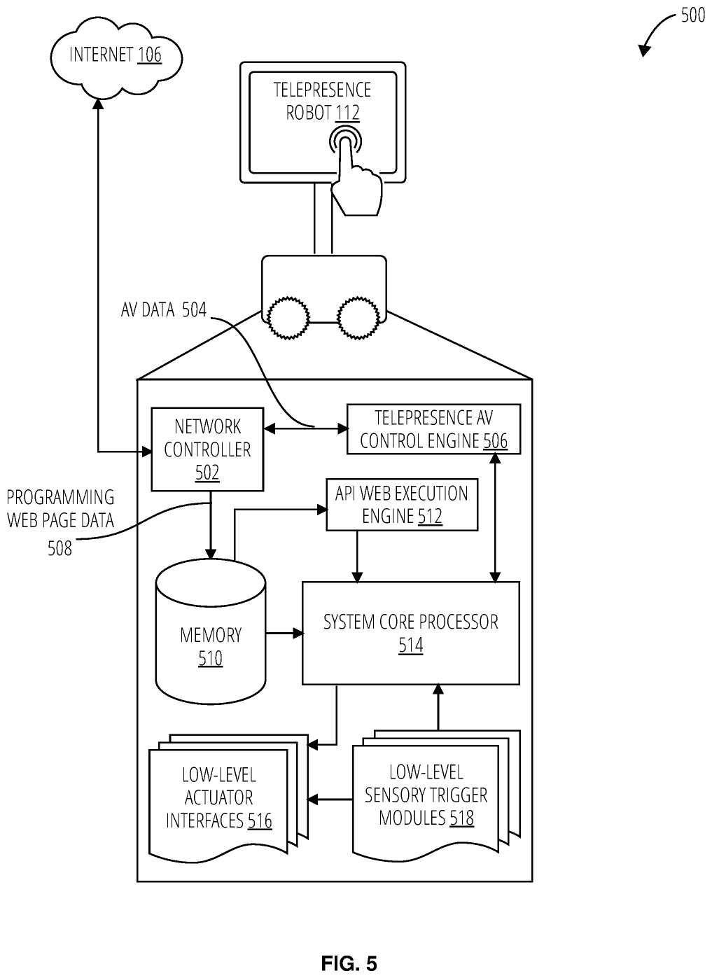

The telepresence robot 112 comprises AV elements and mobility elements that may allow the robot to provide face-to-face communications between geographically remote users. AV elements may include a touch-screen video monitor, speakers, a video camera, and a microphone. Mobility elements may include motors, wheels or continuous treaded tracks, and proximity sensors to detect surrounding objects. In addition to actuating, sensing, AV logic, and system core processor logic components, the telepresence robot 112 may receive code deployed over the Internet 106 and process it through an API web execution engine. These components are illustrated in more detail in FIG. 5.

The telepresence robot 112 is only one embodiment of a robotic platform that may be controlled and deployed more easily as part of the system disclosed herein. Other embodiments of robotic platforms, such as autonomous food delivery robots, or any robot having a high-quality, robust user interaction interface as a default capability, may benefit greatly from the method and system of this disclosure.

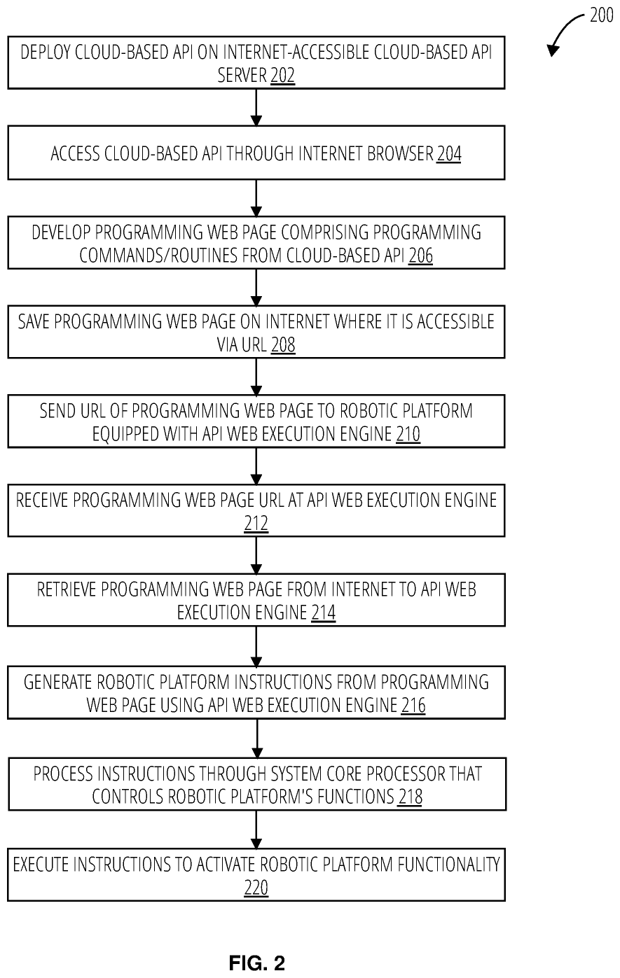

Referring to FIG. 2, a method 200 comprises the illustrated steps, described in further detail below.

According to the method 200, a cloud-based API may be deployed on an internet-accessible, cloud-based API server (block 202). The API may comprise programming commands and routines for controlling a telepresence robot. These programs and routines may be based on a common scripting language, such as JavaScript. In an alternative embodiment, access to the cloud-based API may be provided through wired access, directly to the server, over a local intranet.

The cloud-based API may be accessed through the Internet using an Internet browser (block 204). Internet browsers frequently come on typical computer workstations and are applications in general use. Example Internet browsers may include Microsoft Edge, Google Chrome, Apple's Safari, etc.

The program developer may create a programming web page using the commands/routines defined in the cloud-based API (block 206). This programming web page may also contain video, audio, image, and text files from the Internet, links to additional web pages, scripted GUIs, and browser extension interactive code.

The program developer may save the programming web page at a location accessible via the Internet (block 208). This may be the developer's own web server, a corporate server, or a web server hosted by a third party, such as WordPress, as long as the programming web page can be accessed at a unique URL.

The program developer may use the cloud-based developer interface to send the URL of the programming web page to a telepresence robot (block 210). In this way, a single programming web page may be accessed by multiple robots at a time and may be accessed any number of times.

The programming web page URL may be received by the API web execution engine onboard the robot (block 212). Multiple URLs may be saved into a queue in memory, to be processed based either on order of arrival (first in first out, first in last out, etc.), or on some additional layer of prioritization logic.

The API web execution engine may retrieve the programming web page from the internet (block 214). The programming web page content may be stored in the robot's memory while code on the page is being executed.

The API web execution engine may generate instructions readable by the system core processor from code on the programming web page (block 216).

The system core processor may process the instructions sent from the API web execution engine and send low-level commands to actuators, sensors, AV components, and other robotic hardware (block 218).

The robot may execute the instructions (block 220), which may include timed motion in a specific direction, illuminating onboard light emitting diode (LED) lamps in certain on/off patterns and colors, performing basic telepresence AV functions, or performing telepresence functions augmented with additional Internet content.

Referring to FIG. 3, a developer system 300 comprises a computer workstation 102 with a browser open to the cloud-based developer interface 104. The cloud-based developer interface 104 includes a telepresence app/browser client 302, an in-call API sandbox 304, and a robot programming interface 306.

The telepresence app/browser client 302 provides basic telepresence functionality. It may accept input from web cameras and microphones integrated into the computer workstation 102 or attached as peripherals to transmit the computer workstation user's or developer's voice and image to the remote target user interacting physically with the telepresence robot. The telepresence app/browser client 302 may also display or play the AV input from the telepresence robot's cameras and microphones on a screen and speakers integrated into the computer workstation 102 or attached as peripherals.

An API sandbox is generally defined as a separate environment mimicking the characteristics of a production environment. The sandbox allows developers to run code that is isolated from some main body of programming, while still accurately simulating the behavior of that code within the main body of programming. For the purposes of this disclosure, an “in-call API sandbox” is an isolated execution environment allowing additional code to run without disrupting an AV telepresence call. Code run in the in-call API sandbox 304 may act as an overlay to the code establishing AV telepresence while the telepresence robot is in-call, such as AV data streaming and AV control logic. The in-call API sandbox 304 may be a JavaScript and HTML engine and may be an inline frame (IFRAME) or some other isolated execution context. Using the in-call API sandbox 304, a third-party web application may be securely loaded and overlaid on top of an active telepresence call, without the third-party application needing to reimplement telepresence audio, video, and control logic. When run in this context, the third-party web application may have privileged access to robot sensors, actuators, and system commands.

The robot programming interface 306 may be the main application controlling the telepresence robot. It may be accessed through a typical Internet browser, with no need for a specialized, stand-alone application. The user may log into a web portal hosted on the cloud-based API server and view a list of the robots registered under the user's account. The user may select a desired robot to open a robot programming interface 306 that will communicate with the selected robot. The name 308 of the telepresence robot selected for interaction may appear at the top of the browser window. An options dialog 312 link may appear below this, providing the developer with access to a set of control and information fields. A sharing dialog 310 link may also be provided, allowing the developer to share control of the robot with additional users.

The name entry field 314 may be listed under the options dialog 312 allowing the user to change the telepresence robot's name 308. A light color entry field 316 may follow, allowing the user to set the color of LED lamps installed on the telepresence robot. A homepage entry field 318 may allow a URL to be saved as the robot's homepage. The robot may execute the commands on this page when it powers up. A load page entry field 320 may allow a URL to be loaded immediately, adjusting the robot's programming in real-time with a single click. An overlay HTML entry field 322 may allow the developer to enter a URL for commands the robot will execute through the in-call API sandbox 304, as an overlay to commands or telepresence calls already in progress.

A version 324 may be displayed, which may allow the user to reference what version of the API platform the telepresence robot has been updated to be compatible with. A button may be provided nearby to command the robot to start an update to acquire newer code. Support tools 326 may be provided, such as a button allowing a remote reboot of the robot. The Wi-Fi status 328 of the network in the robot's geographical location may be provided.

Referring to FIG. 4, the server system 400 comprises a developer interface host 402, API programming command and routine libraries 404, an in-call AV routing module 406, a command routing module 408, and optional programming web page libraries 410.

The developer interface host 402 may be where the cloud-based developer interface 104 accessed via Internet browser resides. Coding here may determine the structure and visual layout of the robot programming interface 306. This module may also distinguish data packets related to telepresence AV calls that are routed in real time during a telepresence call and command data packets in the form of web page URLs.

In-call AV data may be directed to an in-call AV routing module 406. This module may act as a standard router, transmitting AV packets between a computer workstation user or developer and remote target user based on unique addressing. Addressing may typically be IP addressing assigned to devices on a network or may be based on MAC addresses programmed into network adapter hardware.

A command routing module 408 may receive the target URLs of programming web pages 412 from the cloud-based developer interface 104. The command routing module may send these URLs to the addressed robot with instructions to stop any program in progress and immediately load the code at the URL target. It may instruct the robot to load the page for execution at start-up. It may also instruct the robot to process the code in parallel with programs in progress, so that the content of the target web page will be processed as an overlay to a call in progress.

Upon receiving AV packets during a call, the telepresence robot 112 may display and play the appropriate AV data on available AV output devices, such as a touch-screen monitor and speakers. Upon receiving a URL command, the telepresence robot 112 may either continue or abort the call as instructed. The robot may follow the URL to fetch the target page, then load the target page into a memory stack and process the code contained in the web page through an API web execution engine. This is illustrated in more detail in FIG. 5.

Referring to FIG. 5, a robot system 500 comprises a network controller 502, a telepresence AV control engine 506, memory 510, an API web execution engine 512, a system core processor 514, low-level actuator interfaces 516, and low-level sensory trigger modules 518.

The network controller 502 may process information received from the Internet 106. AV data 504 packets may be routed to the telepresence AV control engine 506. Programming web page data 508 packets, including command URLs and HTML file content, may be stored in the memory 510 and processed by the API web execution engine 512 in the order or arrival or some other order.

The telepresence AV control engine 506 may be a proprietary audio, video, and control engine. This may be an optimized telepresence stack that handles two-way streaming, encoding, decoding, synchronization, and low-latency remote control of the telepresence robot 112.

The API web execution engine 512 may be the telepresence robot side of an API sandbox. It may be a full HTML and JavaScript engine or any other engine that loads a third-party API web application and is capable of executing it as stand-alone code (i.e., when the robot is not in-call). This may be the same as the in-call API sandbox 304, except that the latter may be used when embedding the API web application into an active call, while the former may be used to deploy an API web application to a robot that is not in a call. Standard web coding such as HTML and JavaScript from the programming web page may be processed by the API web execution engine 512 into commands understood by the system core processor 514.

The system core processor 514 may be the core embedded system that handles communications with and control of low-level actuator interfaces 516, low-level sensory trigger modules 518, cameras, batteries, etc. The system core processor 514 may process the commands received from the API web execution engine into low-level actuator/sensor instructions. Low-level module composition, voice recognition, object detection, etc., may be exposed as a high-level sensory filter system. This may simplify scripting what the robot detects and executing higher level behavior, while the low-level control may be hardware-optimized and capable of deep learning.

Low-level actuator interfaces 516 may use low-level logic to control motors and joints in the robot. Controls coming from the API or user-created code may be translated into low-level motion commands by a control engine within the system core processor 514. The low-level actuator interfaces 516 may encapsulate a command such as “spin at 0.3 radians/sec angular velocity for 2 seconds with angular acceleration of 0.1 radians/sec\hat{ }2” as a binary message packet, or another type of message packet, depending on the attached motor. The low-level actuator interfaces 516 may also be responsible for confirming the packet is received by the motor or other actuator. The low-level actuator interfaces 516 may also handle input from the low-level sensory trigger modules 518.

The low-level sensory trigger modules 518 may be various modules that continuously monitor the telepresence robot 112 surroundings and trigger when certain environmental conditions are met. For example, speech triggers may watch for audio until certain sounds are heard, then send a notification back through the system and through the notification infrastructure, such that the in-call or standalone API code may react appropriately. Other triggers may include deep learning-based visual object detection. This decouples the low-level (high-performance) sensing infrastructure from the flexible, high-level robot programming via the API.

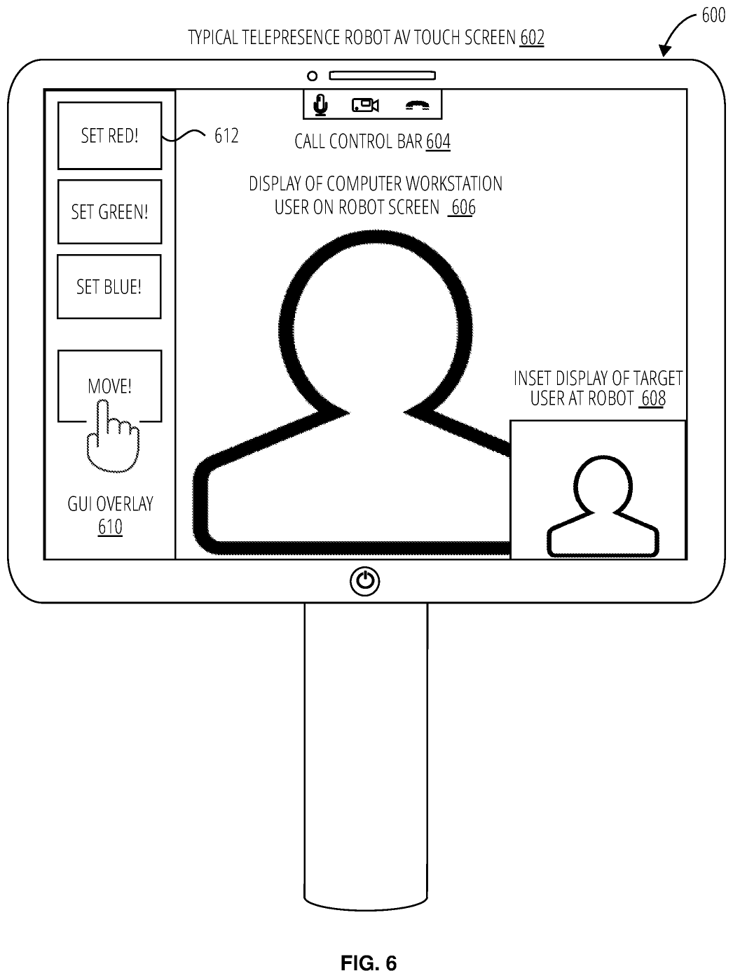

Referring to FIG. 6, a remote target user display 600 shown on a typical telepresence robot AV touch screen 602 comprises a call control bar 604, a display of computer workstation user on robot screen 606, and an inset display of target user at robot 608. Overlay code may be executed to incorporate a GUI overlay 610.

The call control bar 604 may allow the remote target user interacting with the telepresence robot to mute their own audio, mute their own video, or hang up from the telepresence call.

A display of computer workstation user on robot screen 606 may take up the majority of the screen. This display may comprise video captured at the computer workstation of whoever is controlling the telepresence robot.

A small inset display of target user at robot 608 may be shown in a corner of the screen. This may comprise video captured by the robot itself and may enable the remote target user interacting directly with the robot to view what video content is being transmitted to the controlling user or developer at the computer workstation.

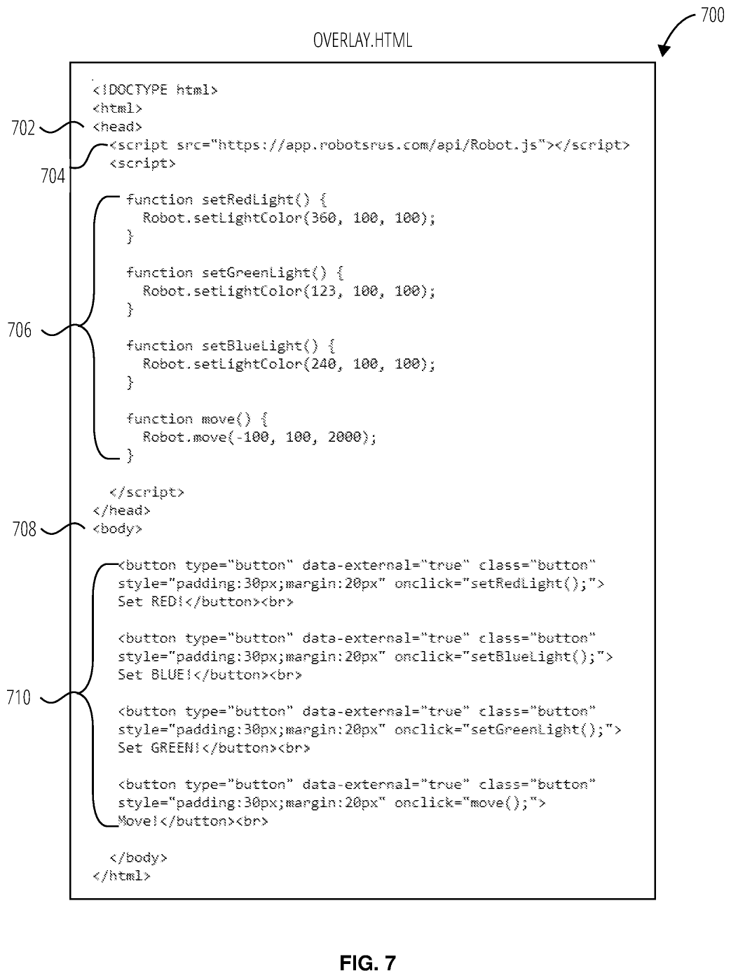

Additional code in an overlay web page may be used to generate a GUI overlay 610 on some portion of the screen. The display of this overlay may result from both HTML coding and scripting using the cloud-based API. Sample code that may create a GUI overlay 610 such as the one shown here is shown in FIG. 7.

Referring to FIG. 7, a typical programming web page 700 may comprise sample file named “overlay.html”. Sending the URL for this file to the telepresence robot using the overlay HTML entry field 322 in the cloud-based developer interface 104 may cause a GUI overlay to be displayed on a typical telepresence robot AV touch screen 602.

Within the HTML file, the header section 702 may contain an API call 704, allowing programming commands and routines from the cloud-based API to be used in the web page. Also in the header section 702, functions using API commands 706 may be defined to control what the GUI overlay does.

In the body section 708 of the code, other web code 710 commands may be used to control how the GUI overlay is displayed on screen and how the remote target user may interact with the GUI.

For example, the Set RED! 612 button may call the first function listed in the header section 702, “setRedLight( )”, when clicked. The function setRedLight( ) may be defined to call the cloud-based API command “Robot.setLightColor(360, 100, 100)” wherein the parameters for this command (360, 100, and 100) may correspond to level and position settings for LED lamps onboard the robot. This may comprise what the button in the GUI does.

The first line of code in the body section 708 (“<button . . . >”) may define an object that is a button, has the padding and margin defined in “style” parameters, calls the function “setRedLight( )” when clicked, and is labeled with the text “Set RED!”. This may comprise how the GUI displays, and how the display elements allow the user to activate what the GUI does.

Through the method and system disclosed here, code as simple as this may be deployed with a single click to augment the functionality of a telepresence robot. This functionality may be incorporated without disrupting a telepresence call in progress between a computer workstation user or developer and a remote target user in the same location as the telepresence robot.

The methods and systems in this disclosure are described in the preceding on the basis of several preferred embodiments, the primary embodiment of a robotic platform being a telepresence robot. Different aspects of different variants are considered to be described in combination with each other such that all combinations that upon reading by a skilled person in the field on the basis of this document may be regarded as being read within the concept of the invention. The preferred embodiments do not limit the extent of protection of this document.

Having thus described embodiments of the present invention of the present application in detail and by reference to illustrative embodiments thereof, it will be apparent that modifications and variations are possible without departing from the scope of the present invention.

What is claimed is:

1. A method comprising:
deploying a cloud-based application programming interface (API), wherein the cloud-based API comprises programming commands and routines for controlling a robotic platform and exists on a cloud-based API server that is accessible to program developers through the Internet;
accessing the cloud-based API, wherein access is accomplished through the Internet using an Internet browser installed on a computer workstation;
developing a programming web page, wherein the programming web page is constructed by the program developer as a standard web-based programming language file, includes a command to include the cloud-based API within the web-based programming language file, and contains the programming commands and the routines included in the cloud-based API;
saving the programming web page on the Internet, wherein the programming web page is accessible to the robotic platform via a uniform resource locator (URL);
sending the URL at which the programming web page is accessible to the robotic platform using a cloud-based developer interface, wherein the cloud-based developer interface exists on the cloud-based API server, the robotic platform is connected to the cloud-based developer interface through the Internet, the robotic platform includes an API web execution engine, and the API web execution engine includes logic for generating instructions for the robotic platform from the programming web page;
receiving the URL at which the programming web page is accessible at the API web execution engine;
retrieving the programming web page from the Internet to the API web execution engine;
generating the instructions for the robotic platform using the API web execution engine;
processing the instructions through a system core processor, wherein the system core processor exists in the robotic platform and controls at least one of the motion, sensing, and user input/output (I/O) functions of the robotic platform; and
executing the instructions to control at least one of the motion, sensing, and user I/O functions.

2. The method of claim 1, wherein the programming web page is an HTML file.

3. The method of claim 1, wherein the programming web page is an XML file.

4. The method of claim 1, wherein the programming web page includes links to at least one of video, audio, image files, and combinations thereof, that exist on the Internet.

5. The method of claim 1, wherein the programming web page includes links to other web pages that exist on the Internet, wherein the other web pages include at least one of additional programming web pages the robotic platform executes, informational web pages the robotic platform displays providing information useful to persons interacting with the robotic platform, and combinations thereof.

6. The method of claim 1, wherein the programming web page includes commands to construct graphical user interfaces (GUIs).

7. The method of claim 1, wherein the programming web page includes commands that interact with browser extension code incorporated into the Internet browser.

8. The method of claim 1, wherein the programming web page sent to the robotic platform comprises the programming commands that allow the robotic platform to control other robots compatible with the robotic platform.

9. The method of claim 1, wherein the program developer accesses a shared library on the cloud-based API server to upload the programming web pages, wherein the programming web pages are created by the program developer.

10. The method of claim 1, wherein the program developer accesses the cloud-based API via a wired or wireless Intranet connection to the cloud-based API server.

11. A system comprising:
a cloud-based developer interface, wherein the cloud-based developer interface is accessible to program developers over the Internet and provides a graphical user interface (GUI), wherein the GUI allows the program developer to send a uniform resource locator (URL) to a robotic platform;
a cloud-based application programming interface (API), wherein the cloud-based API is located on a server that is accessible to the program developers over the Internet and comprises programming commands and routines for controlling the robotic platform;
a cloud-based API server, wherein the cloud-based API server hosts the cloud-based developer interface, stores the cloud-based API, comprising the programming commands and the routines for controlling the robotic platform, includes routing logic, and the routing logic allows the program developer to access the robotic platforms; and
the robotic platform, wherein the robotic platform connects to the Internet and has an API web execution engine capable of processing the programming commands and the routines in the cloud-based API.

12. The system of claim 11, wherein the cloud-based developer interface allows the program developer to send the URL at which a homepage is accessible, wherein the homepage is a programming web page and wherein the URL is stored in memory within the robotic platform, and the robotic platform reads the URL and accesses and executes the homepage at startup.

13. The system of claim 11, wherein the cloud-based developer interface allows the program developer to send the URL for a homepage, wherein the homepage is a programming web page and wherein the robotic platform downloads the homepage located at the URL, saves the homepage in memory within the robotic platform, and executes the homepage at startup.

14. The system of claim 11, wherein the cloud-based developer interface allows the program developer to send the URL for a programming web page and wherein the programming commands and the routines included in the programming web page are executed immediately instead of the programming commands and the routines the robotic platform is in process of executing.

15. The system of claim 11, wherein the cloud-based developer interface allows the program developer to send the URL for a programming web page and wherein the programming web page is executed as an overlay to the programming commands and the routines the robotic platform is in process of executing.

16. The system of claim 11, wherein the cloud-based developer interface allows the program developer to perform at least one of the following:
assign a name to the robotic platform;
modify the name assigned to the robotic platform;
assign a color setting for LED lamps incorporated into the robotic platform;
perform a remote code update of the robotic platform;
perform a remote reboot of the robotic platform; and
some combination thereof.

17. The system of claim 11, wherein the cloud-based API server includes a library to which the program developer uploads the programming commands and the routines that the program developer develops.

18. A robotic platform, the robotic platform comprising:
a mobility system controlling motion of the robotic platform;
a sensory system providing environmental data;
a network controller providing a connection to the Internet;
an application programming interface (API) web execution engine, wherein the API web execution engine translates a programming web page into instructions for at least one of the robotic platform's motion, sensing, and user input/output (I/O) functions; and
a system core processor, wherein the system core processor processes the instructions from the API web execution engine and executes the instructions to control at least one of the motion, sensing, and user I/O functions of the robotic platform.

19. The robotic platform of claim 18, wherein the robotic platform incorporates a wired connection over which a program developer may upload the programming web pages directly to memory within the robotic platform.

20. The robotic platform of claim 18, wherein the robotic platform is a telepresence robot, further comprising an audiovisual (AV) input and output system providing face-to-face communication functionality, including at least one of a display, speaker, camera, microphone, and combinations thereof.
